(19) United States
(12) Patent Application Publication
(10) Pub. No.: US 2015/0091891 A1
(43) Pub. Date: Apr. 2, 2015

(54) System and method for non-holographic teleportation

(71) Applicants: Fazal Raheman, Dubai (AE); Ali Fazal Raheman, Dubai (AE)

(72) Inventors: Fazal Raheman, Dubai (AE); Ali Fazal Raheman, Dubai (AE)

(73) Assignee: DUMEDIA, INC., Newark, DE (US)

(21) Appl. No.: 14/040,729

(22) Filed: Sep. 30, 2013

(51) Int. Cl. G06T 15/00

(52) U.S. Cl. CPC G06T 15/00
USPC 345/419

(57) ABSTRACT

The present invention discloses a system and method for non-holographic virtual teleportation of one or more remote objects to a designated three-dimensional space around a user in realtime. This is achieved by using a plurality of participating teleportation terminals, located at geographically diverse locations, that capture the RGB and depth data of their respective environments, extract RGB images of target objects from their corresponding environment, and transmit the alpha channeled object images via Internet for integration into a single composite scene in which layers of computer graphics are added in the foreground and in the background. The invention thus creates a virtual 3D space around a user in which almost anything imaginable can be virtually teleported for user interaction. This invention has application in intuitive computing, perceptual computing, entertainment, gaming, virtual meetings, conferencing, gesture based interfaces, advertising, ecommerce, social networking, virtual training, education, so on and so forth.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD OF INVENTION

The present invention generally relates to the field of virtually teleporting in real time, from diverse geographical locations, one or more remote objects, subjects, themes, events, environments, computer graphics, interfaces, seamlessly into user's three-dimensional (3D) space to create an interactive immersive experience. Specifically the invention pertains to creation of a 3D virtual space around a computer user in which almost anything imaginable can be virtually teleported for user interaction. More particularly the invention pertains to a non-holographic real time technique that extracts from their corresponding backdrops, images and depth information of one or more remote objects located at remote teleportation terminals, transmits said images with alpha channel to a host teleportation terminal, extracts host object and composes a composite scene of all participating objects by inserting pre-selected background and foreground computer graphics. More importantly the invention creates a new versatile genre of non-holographic virtual teleportation that has a broad scope applicability in applications such as intuitive computing, perceptual computing, entertainment, gaming, virtual meetings, conferencing, gesture based interfaces, advertising, ecommerce, social networking, virtual training, education, so on and so forth.

### BACKGROUND

In a pending application (U.S. application Ser. No. 13/864,019) the present inventors disclosed a multilayered augmented reality technique that deployed a virtual chroma keying approach that eliminated the requirement of bulky and cumbersome physical chroma screens by making use of digitally generated virtual chroma mask. That approach reduced the size of hard chroma screen background and increased the portability of an Augmented Reality Kiosk. But it did not completely eliminate the need of a reduced size chroma screen. Furthermore, although it added multiple layers of foreground and background computer graphics to the user's 3D space, it did not extract, transmit and insert into the scene objects from remote locations. Adding 2D or 3D foreground and background segmentation techniques for background removal not only completely eliminates the need for hard chroma screen, but creates a virtual 3D space around a user in which almost anything can be teleported from any remote location for user interaction. 3D depth sensing is known in prior art to enable separation of a subject from background within a camera view without any chroma screen, and at the same time capture user movements for interacting with the system. It also opens an entire new way to teleport remote objects between remote geographical locations in real time.

Traditionally, holography has been used for virtual teleportation of human subjects. Ideally, teleportation is defined as transfer of matter from one point to another without traversing the physical space between them. As much as it may be a very cool concept in the popular ScFi culture, for the real world inventors, it is not a matter of actually moving matter, but one of transporting information. In other words, teleportation of a physical being will always be virtual and never real.

In prior art holography is the closest one can get to demonstrate virtual teleportation. However, holography based techniques are unsuitable for adaptation by the masses owing to high cost and time required for creating an extensive set up that requires a 3D laser infrastructure. Therefore, in this disclosure, a system and method for achieving virtual teleportation of one or more remote objects based on non-holographic technique is described. Such a system does not require expensive 3D laser holography infrastructure set up, can be used with any Internet connected computing device, can be installed in minutes, can teleport multiple objects simultaneously in High Definition (HD) resolutions to any real or fictionally created location.

Another need addressed by the present invention relates to perceptual computing, which is of great importance in entertainment, education, productivity, immersive gaming, social networking and most importantly in futuristic contactless or touch-less virtual interfaces. Currently known gesture based algorithms are unable to provide a fine degree of control needed in operating systems such as a computing device wherein data input with the precision of a keyboard, mouse or touchpad is required. They are limited to executing basic commands such as those of starting or stopping an application, or triggering an event. The present invention also addresses this need and finds utility in various applications such as video and computer gaming, entertainment, conferencing, interactive and perceptive computing to create an enriched user experience.

### PRIOR ART

Chou et al., in U.S. Pat. No. 8,375,085 disclose a system and method of enhanced collaboration through teleportation, wherein several remote users collaborate in a virtual environment. Dawson et al., in U.S. Pat. No. 8,392,839 disclose a system and method for using partial teleportation or relocation in virtual worlds by using a facility such as a virtual kiosk at which one can view previously rendered images of portions of one or more teleportation destinations. When full teleportation is initiated, the processing intensive rendering is supplemented from image data representing the portion or the teleportation destination, thus hiding rendering delays and simulating seamless, instantaneous response to the full teleportation operation.

Shin et al., in PCT application no. WO 2001011511 disclose an electronic commerce system and method over three-dimensional virtual reality space, wherein an interactive electronic commerce system using intelligent virtual objects in a three-dimensional virtual reality space over a communication network such as the Internet, is provided. Altberg et al., in PCT application no. WO 2008130842 describe methods and systems to connect people via virtual reality for real time communications with respect to a commercial advertisement. Kikinis et al., in PCT application no. WO 2012054231 disclose a system and method for 3D projection and enhancements for interactivity wherein the system projects a user-viewable, computer-generated or -fed image, wherein a head-mounted projector is used to project an image onto a retro-reflective surface, so only the viewer can see the image.

The above patent disclosures emphasize the need of a cost effective and easy to set up system for achieving virtual teleportation of a plurality of remote objects for enhancing user experience in perceptual computing, entertainment, social networking, gaming, virtual interfaces, education, conferencing applications, or such applications. However, none of the systems and methods described in the prior art disclosures use a non-holographic technique to create a teleportation experience in a customized environment.

### BRIEF SUMMARY OF THE INVENTION

The present invention addresses the foregoing need for an easy to install, cost effective virtual teleportation method and system thereof. It discloses a non-holographic method of virtually teleporting any object from a three dimensional space of a remote location, into a customized environment wherein one or more background layers or background layers of computer graphics may be inserted to render a seamless 3D environment in which all the teleported objects can interact. The system does not employ any laser holography means for recording or replaying image or scene. Furthermore, it also does not deploy any physical chroma screens or chroma keying techniques for background removal, thereby making it an effective and accessible system for the masses.

The present invention is directed to hardware, systems, methods, programs, computer products, computer readable media, interfaces and modules for controlling one or more operating parameters of one or more teleporting devices coupled to one or more computing devices with internet connectivity in different geographic locations for generating a composite scene comprising of a plurality of remote objects against a single customized 3D environment in real time. Accordingly, there is a need for such non-holographic virtual teleportation system and method as summarized herein in some detail.

It is an object of the present invention to provide a virtual teleportation platform wherein interactive video conferencing between several remote objects (participants) is possible, thereby eliminating the need for expensive travel. Other objects of the invention include providing a virtual teleportation system wherein depth, shape and gesture related interactive features are provided to create a realistic and believable 3D environment set up.

A further object of the present invention is to designate a virtual three-dimensional space around a host object at a host teleportation terminal, comprising of one or more human subjects, and to selectively teleport, i.e. virtually transmit images of one or more of remote objects located at different remote teleportation terminals at diverse geographical locations, to the virtual three dimensional space of the host object at the host teleportation terminal.

It is therefore an object of the present invention to provide a new method of virtually teleporting one or more remote objects to a predetermined, customized scene or environment without employing holographic techniques. This object is achieved by, firstly, extracting in real time one or more images of remote object(s) from the camera scene by deploying known foreground and background segmentation techniques, such as 2D pixel recognition and differentiation, or by 3D depth mapping and differentiation; secondly, transmitting and inserting one or more extracted objects into a single teleported host scene; thirdly, inserting layers of computer graphics as background and foreground layers, fourthly, compositing the final teleported scene with the objects and computer graphic layers properly aligned to generate a seamless virtual 3D environment in which each of the teleported objects can interacts.

It is further object of the present invention to provide a system that can be readily and easily used without the need for a sophisticated 3D laser infrastructure set up, and without any specialized knowledge of using 3D recording and replaying paraphernalia. In different embodiments of the present invention, the foreground/background segmentation is achieved by known techniques such as 2D pixel recognition and differentiation, or 3D depth measurement achieved by either dual camera triangulation, or multiple camera array that uses micro or nano lenses, or by means of Time-of-Flight (ToF) sensors, or by means of structured light based sensing methods.

Yet another object of the present invention is to provide a multi-layered perceptual computing interface (MLPCI) that virtually teleports all interactive tools such as keyboard, mouse, pen, page scroller, onscreen navigation links, icons, etc., into user's 3D space, wherein the user can perform sophisticated data input gesture-based interactions without using any proximity hardware like controller, gloves or near field sensor. It is further object of the present invention to enable execution of complex commands such as typing text, otherwise impossible by any gesture recognition system of prior art. It is therefore an object of the invention to enable MLPCI by replacing the background layer with the live screen view of the application that user is interfacing with. It is also further object of the invention to insert the graphic elements of virtual interactive tools as one or more translucent foreground layers and make the user transparent/translucent so that the virtual translucent interface apparently appears to float in the 3D space between the user and the display screen. It is therefore an object to allow user's transparent silhouette guide the user to move his hands and fingers in air for executing any command of desire via the virtual interface with ease.

It is thus an eventual object of the instant invention to create a virtual 3D space around a user and teleport almost anything imaginable within that space, such as friends, family, date, colleagues, store merchandise, venues, events, services, environments, user interfaces and even dreams, for the purpose of intuitive computing, perceptual computing, entertainment, gesture based interfaces, gaming, advertising, ecommerce, social networking, virtual training, education, so on and so forth.

Accordingly, a teleporting device is configured in different embodiments to include singly or in combination, one or more digital RGB cameras, 3D depth sensing (time of flight) ToF camera, 3D depth sensing camera based on structured light imaging, or dual camera depth sensor, or multiple camera array, that can be coupled to an internet enabled computing device.

These advantages in addition to other objects and advantages of the invention will be set forth in the description which follows, and in part will be obvious from the description, or may be learned by the practice of the invention. The objects and advantages of the invention may be realized and obtained by means of software, algorithms, hardware devices, remote servers and combinations thereof particularly pointed out in the appended claims.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results as will be described. Accordingly, referring to the following drawings may have a complete understanding of the invention. Description of several preferred embodiments is as follows.

### BRIEF DESCRIPTION OF THE SEVERAL VIEWS OF THE DRAWINGS

The above-mentioned and other features and advantages of this present disclosure, and the manner of attaining them, will become more apparent, and the present disclosure will be better understood by reference to the following description of embodiments of the present disclosure taken in conjunction with the accompanying drawings, as illustrated herein:

FIG. 1(a): A representative diagram illustrating an embodiment of a system facilitating virtual teleporting of three remote objects in real time using a client-server network architecture.

FIG. 1(b): A representative diagram illustrating an embodiment of a system facilitating virtual teleporting of three remote objects in real time using a Peer-to-Peer architecture.

FIG. 1(c): A representative diagram illustrating an embodiment wherein a user initiates teleportation session by activating Teleportation Icon 140 on a virtual interface by means of hand gesture.

FIG. 1(d): A representative diagram illustrating an embodiment wherein an invitation to teleport is sent to selected participants from contact list.

FIG. 1(e): A representative diagram illustrating an embodiment wherein the invited participants accept the invite to teleport.

FIG. 1(f): A representative diagram illustrating an embodiment wherein the initiator of the teleportation session selects the location to teleport participants (such as under water expedition).

FIG. 1(g): A representative diagram illustrating an embodiment wherein the teleportation process commences.

FIG. 1(h): A representative diagram illustrating an embodiment wherein the initiator is being teleported to the desired virtual location.

FIG. 1(i): A representative diagram illustrating an embodiment wherein the invitees to the teleportation session join the initiator of the teleportation session at the selected virtual location.

FIG. 1(j): A representative diagram illustrating an embodiment wherein the session initiator ends the teleportation session by activating “End Session” option on a virtual interface by means of hand gesture.

FIG. 2: A representative diagram illustrating an alternate embodiment of a system facilitating virtual teleporting for an e-commerce application.

FIG. 3: A representative diagram illustrating a multi-layered perceptual computing interface (MLPCI) embodiment for creating a virtual interface.

FIG. 3(a): Illustrative screenshot of a virtual interface embodiment of the present invention wherein the user gestures the START icon 316 for launching the application.

FIG. 3(b): Illustrative screenshot of a virtual interface embodiment wherein the user launches the target application 318 (Internet Browser) by hand gesture.

FIG. 3(c): Illustrative screenshot of a virtual interface embodiment wherein the user activates the cursor by launching the virtual touchpad 320 to move the cursor on the target application page.

FIG. 3(d): Illustrative screenshot of a virtual interface embodiment wherein the user launches and uses the virtual keyboard 322.

FIG. 3(e): Illustrative screenshot of a virtual interface embodiment wherein the user launches and uses the virtual page scrolling function 324.

FIG. 3(f): Illustrative screenshot of a virtual interface embodiment wherein the user uses gesture controlled drawing tool function 326 to draw and to close the application.

FIG. 4: An exemplary block diagram illustrating the operating modules of a virtual teleporting system.

FIG. 5: An illustration of the process flow steps deployed in an embodiment of the present invention.

FIG. 6: A representative diagram illustrating integration of different modules of the embodiment within a television set or a display monitor.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. Exemplary embodiments of the present invention are directed towards a system and a method for facilitating non-holographic virtual teleporting in real time directed at one or more remote objects.

It is advantageous to define several terms, phrases and acronyms before describing the invention in detail. It should be appreciated that the following terms are used throughout this application. Where the definition of term departs from the commonly used meaning of the term, applicant intends to utilize the definitions provided below, unless specifically indicated. For the purpose of describing the instant invention following definitions of the technical terms are stipulated:

1. 2D foreground segmentation: Two dimensional image segmentation techniques for distinguishing a background from a foreground, such as those based on pixel recognition and differentiation. The 2D pixel differentiation technique requires a training session so that the system first reads and learns the pixel pattern in a given scene and uses it as a reference to extract target object from the background.

2. 3D background segmentation: Three dimensional image segmentation techniques such as those based on depth measurement techniques by dual camera triangulation algorithm, multiple camera array, Time-of-Flight 3D mapping, or structured light based 3D imaging processes.

3. Teleporting device/Teleporting terminal: A computer device or a combination of devices coupled to an internet enabled computing device comprising of at least one RGB (Red, Green, Blue) sensor, which is a high definition camera with HD resolution of 720P (1280×720 pixels) or Full HD resolution of 1080P (1920×1080 pixels) that captures the live object images at each of the teleporting terminal; at least one audio sensor, and at least one depth sensor, which is based on generating 3D maps of the objects at each of the teleportation terminal using one of the following approaches: a) Time-of-Flight based depth sensing, b) Structured Light based 3D sensing, c) using Dual Camera based triangulation algorithm, or d) by means of Multiple Camera Array method. The complete assemblage of Internet-connected teleportation enabling hardware and software at a specific geo-location is referred as teleporting terminal. A teleporting terminal that deploys two-dimensional segmentation may not need the depth sensor.

4. Time-of-Flight Depth Sensor: A time-of-flight sensor or camera (ToF camera) is a range imaging camera system that resolves the depth of an object by measuring the time-of-flight of a light signal between the camera and the subject for each point of the image distance based on the known speed of light.

5. Structured Light Depth Sensor: Another type of depth sensor that is used for measuring the three-dimensional shape of an object using projected light patterns and a camera system.

6. Dual Camera Depth Sensor: Depth of a three-dimensional object can also be measured by using two RGB cameras for capturing image data points on the object from two different perspectives, and then using triangulation algorithm to analyze all the data points for creating a 3D map of the object.

7. Multiple Camera Array: Using an array of multiple cameras to record a scene is a more recent technique that is used to generate pixel specific data from multiple perspectives. In this system each pixel carries depth information in addition to the normal RGB data. Such pixel-specific information can be deployed in many different ways, one of which being creating a depth map of the image. An array may comprise of either multiple micro cameras with their own imaging sensors, or a collection of miniaturized micro or nano lenses focusing light from different perspectives on a single processor chip collectively analyzing the entire image information from all perspectives to measure the depth of each pixel from each perspective.

8. Remote object/s & Remote terminal/s: One or more human subjects, living beings, physical objects or articles located in a designated three dimensional space in a single or multiple geographical locations who are to be virtually teleported to a different location. The complete assemblage of teleportation enabling hardware and software infrastructure at such a remote location is referred as remote terminal.

9. Host Object/s: One or more human subject, living being located in a designated three-dimensional space in a geographical location, who initiate a teleportation session with one or more remote teleportation terminals, and who are to be virtually teleported to a pre-defined virtual location. The complete assemblage of teleportation enabling hardware and software at such a host location is referred as host terminal.

10. Camera view background: The local background environment surrounding each of one or more remote object(s) or host object(s) from which the corresponding object(s) have to be extracted and transmitted with alpha channel (transparency) to the host terminal, so that various teleported or computer generated graphic elements can be integrated into a composite teleported scene.

11. Teleported scene background layer: The background layer comprising of one or more preselected computer generated graphic content, retrieved from a repository, for insertion into the integrated, composite teleported scene.

12. Teleported scene foreground layer: The foreground layer comprising of one or more preselected computer generated graphic content, retrieved from a repository, for insertion into the integrated, composite teleported scene.

13. Elements of a teleported scene: The remote object(s), host object(s), computer generated background graphics layer(s), computer generated foreground graphics layer(s), and alpha and audio channel associated with each of them constitute the elements of the teleported scene.

14. Remote Object Connection Module (ROCM): A set of computer programs that is used to logically connect one or more remote objects in real time via internet means that include but are not limited to a telecommunication link, or a wired or wireless local area network (LAN), or a wide area network (WAN), or a virtual private network (VPN) or intranet through wired or wireless telecommunication protocol, or TCP/IP protocol, or GPRS protocol or WiFi protocol or Bluetooth or radiofrequency protocol or a telecommunication protocol.

15. Object Scene Capture Module (OSCM): A set of computer programs that receive, as input from RGB sensor, the image of object scene in real time from the teleporting device

16. Object Extraction Module (OEM): A set of computer programs that rely on 2D or 3D background and foreground segmentation techniques to extract in real time scene objects from their backgrounds.

17. Remote Object Transmission Module (ROTM): A set of computer programs that transmit in real time, to a host object terminal, the extracted image of a remote object along with associated parameters, those include but not limited to depth, texture, color, alpha channel and audio channel.

18. Object Insertion Module (OIM): A set of computer programs that integrates, places and composes one or more remote teleported objects within alpha channeled areas of extracted host object image scene.

19. Foreground Layer Insertion Module (FLIM): A set of computer programs that inserts in real time a pre-defined foreground layer of computer graphics to the composition of teleported scene.

20. Background Layer Insertion Module (BLIM): A set of computer programs that inserts in real time a pre-defined background layer of computer graphics to the composition of teleported scene.

21. Teleported Scene Compositing Module (TSCM): A set of computer programs that integrates and fine tunes in real time the composition of all the elements of the teleported scene, such as host and remote objects, background and foreground layers of computer graphics, alpha channel and audio channel to produce a live composition of teleported environment.

22. Teleported Composite Scene Display Module (TCSDM): A set of computer programs that display in real time the integrated, composite teleported scene on display devices of each of the participating teleportation terminals.

23. Communication Module (CM): A set of computer programs which delivers the integrated, composite teleported scene in real time to a preselected destination using either wired or wireless telecommunication protocol, or TCP/IP protocol, or WiFi protocol or Bluetooth, or a radiofrequency protocol.

24. Central Processing Unit (CPU): A computing system that analyzes and executes the operations of ROOM, OSCM, OEM, ROTM, OIM, FLIM, BLIM, TSBLIM, TCSM, TCSDM.

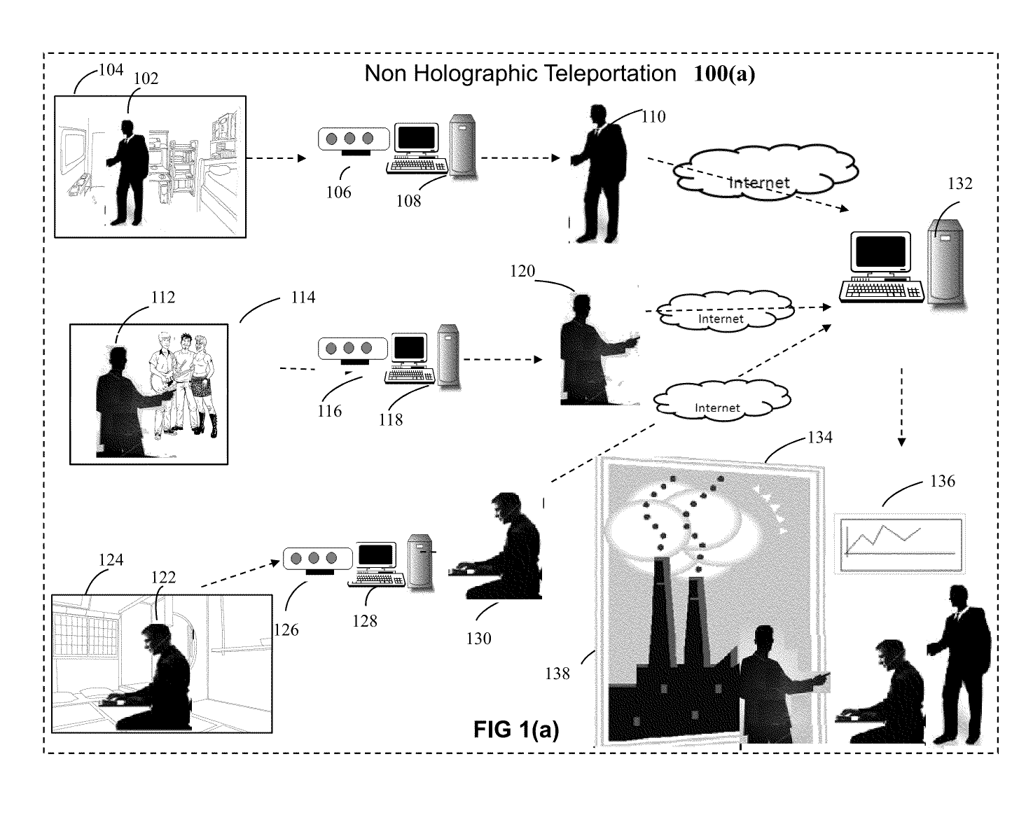

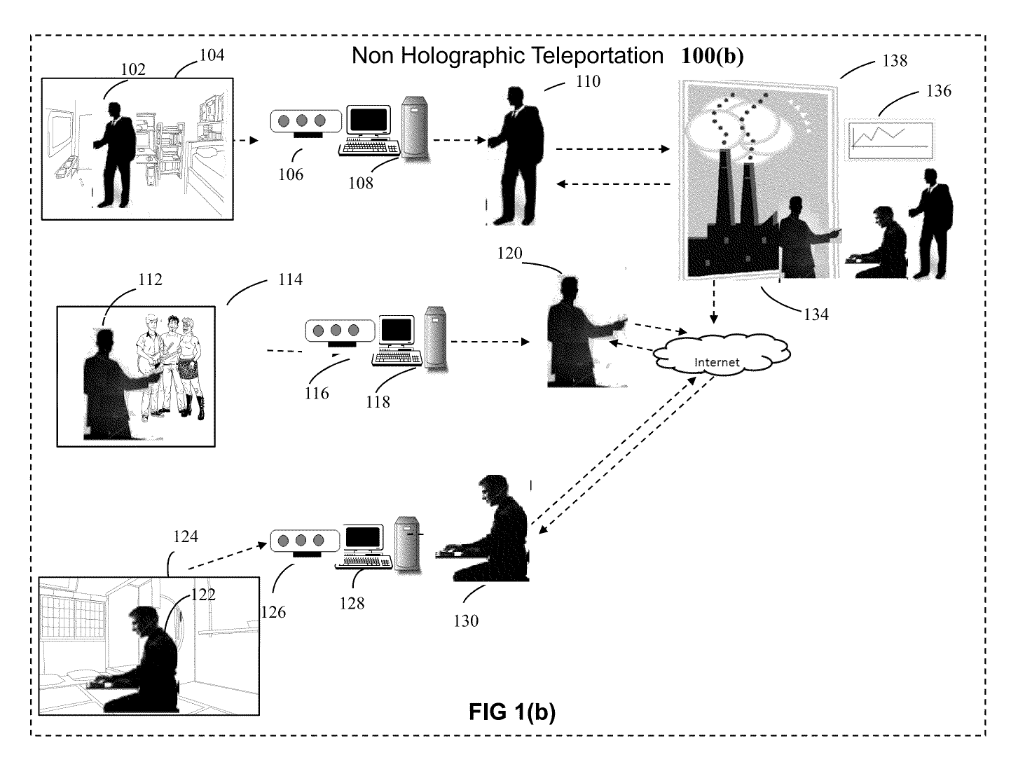

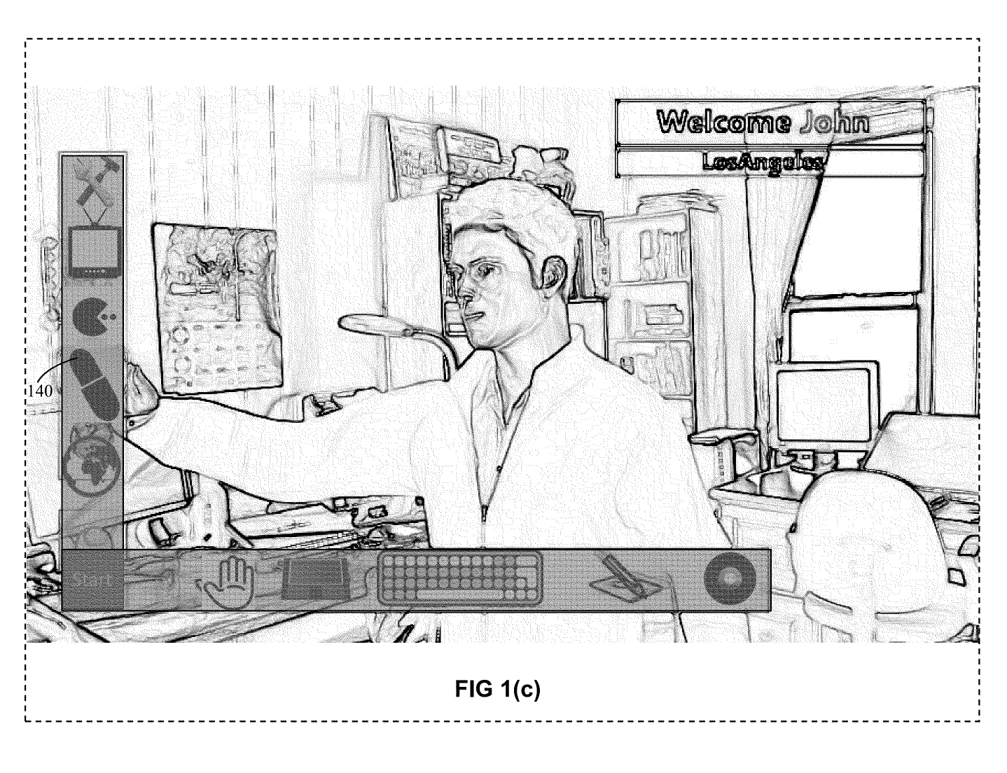

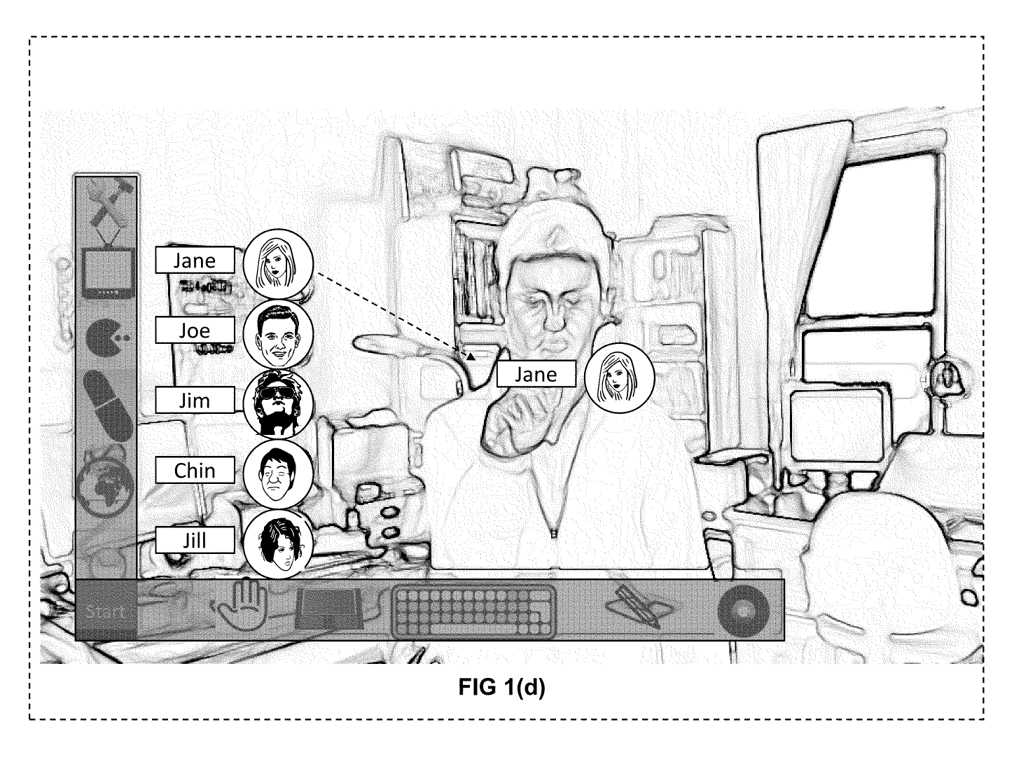

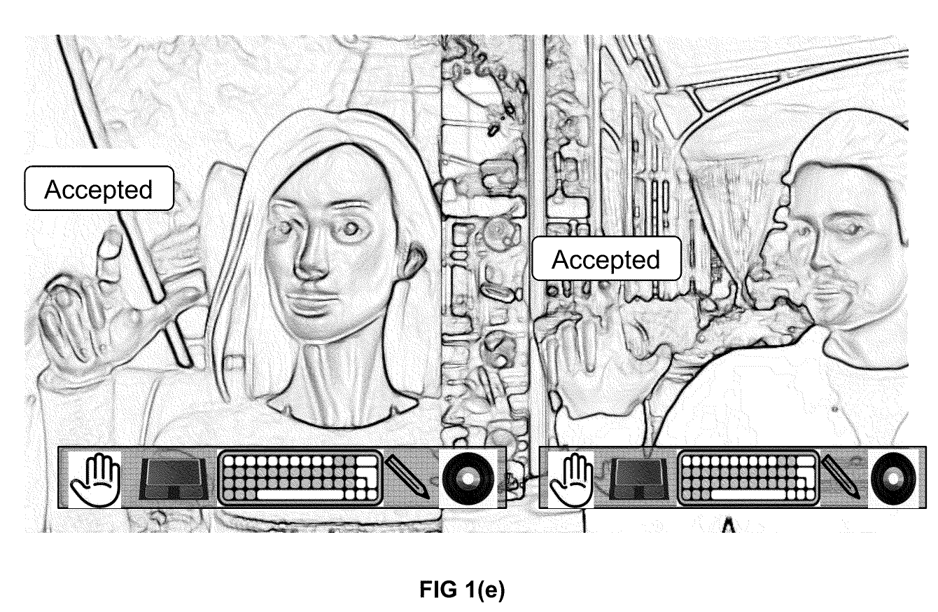

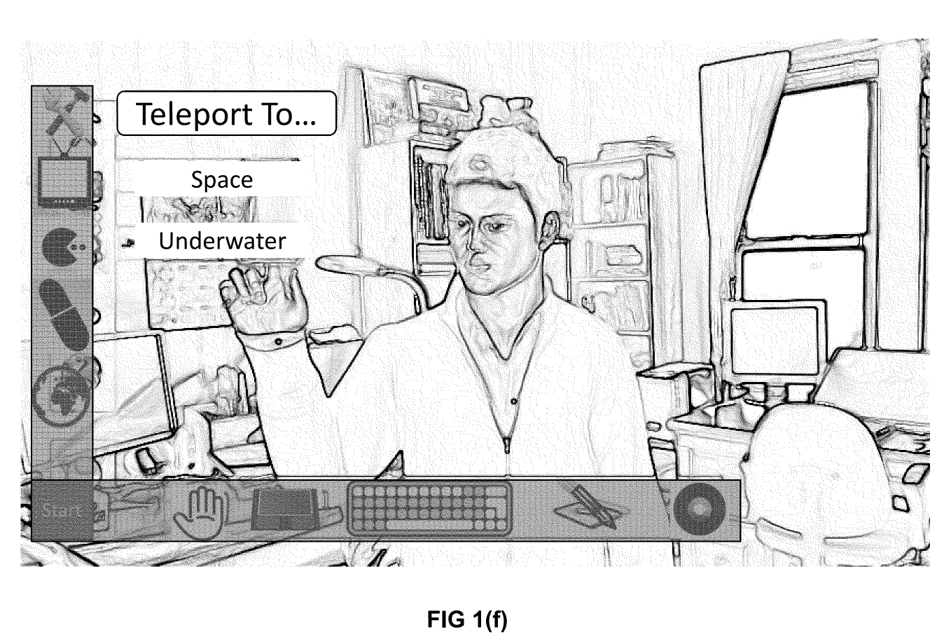

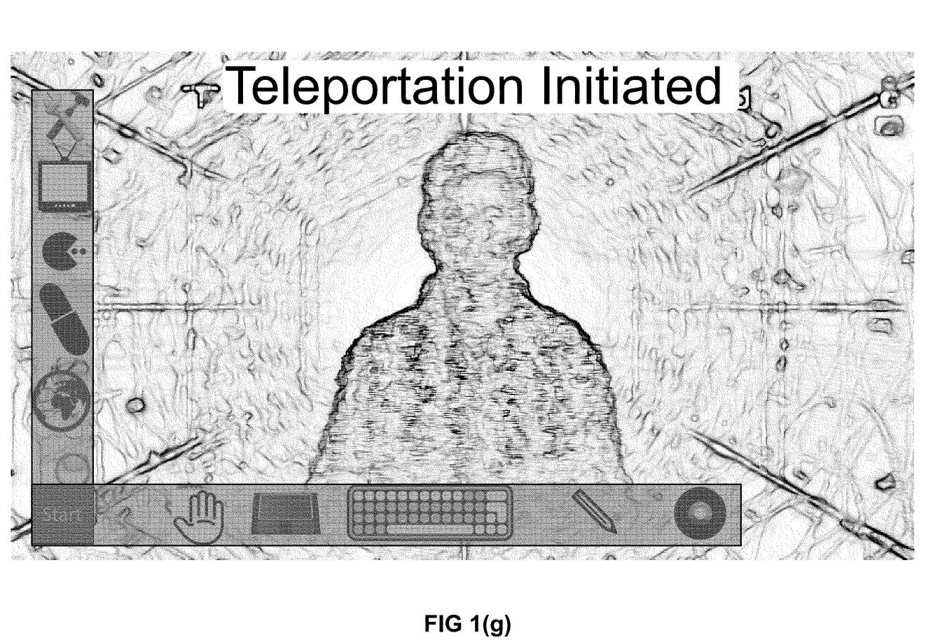

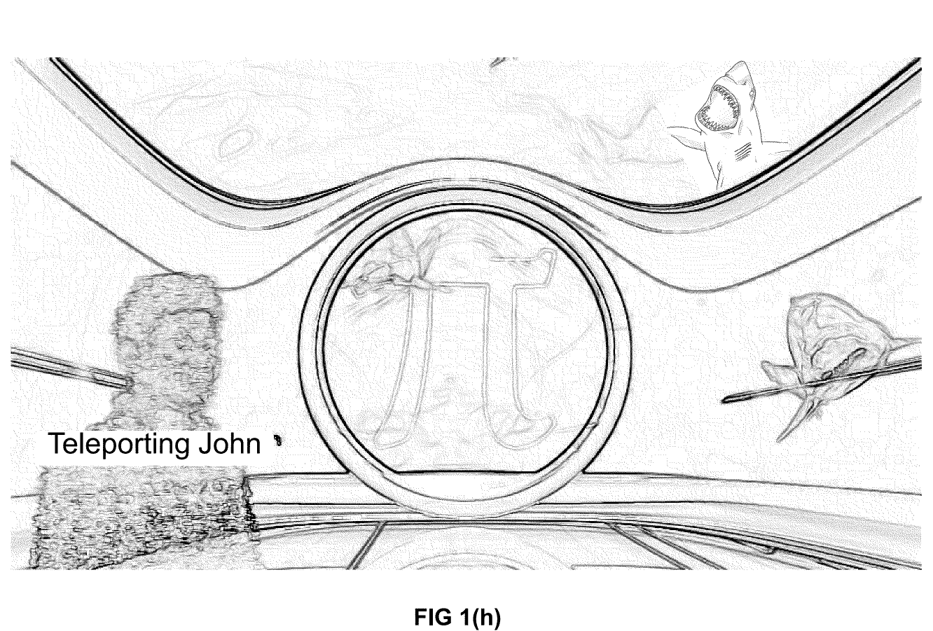

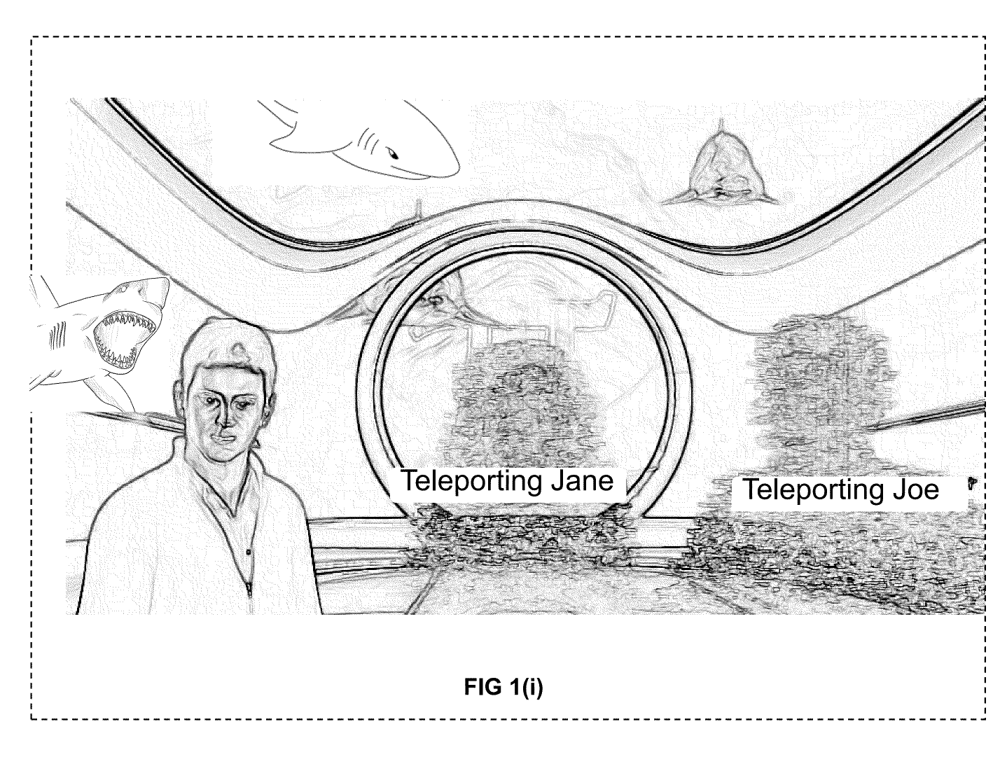

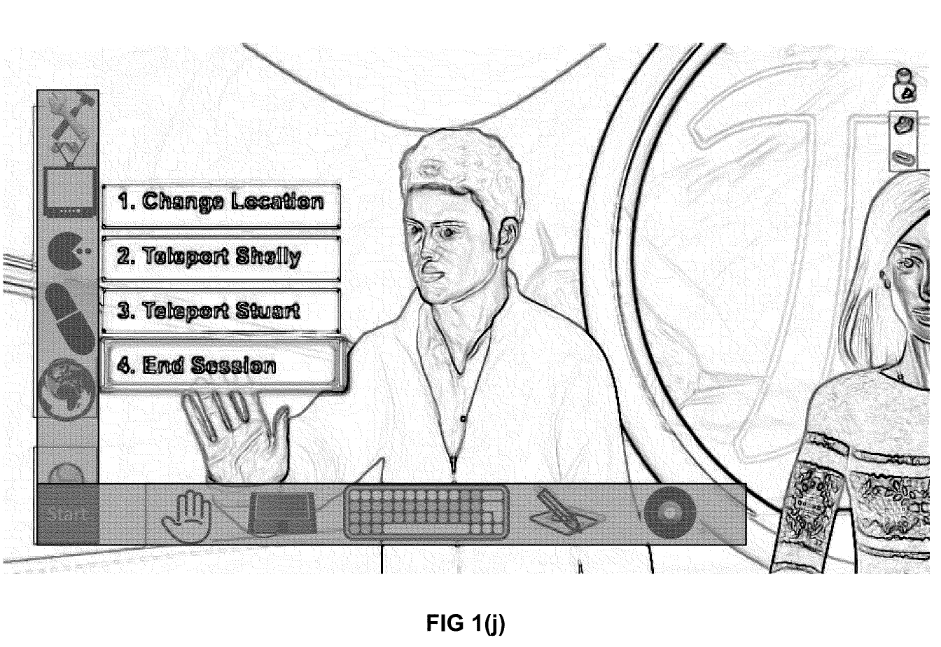

The present invention is now described with reference to the drawings. An overview of a system in a preferred embodiment facilitating virtual teleportation of three remote objects in a teleportation session to a new real or virtual location using non-holographic technique is now discussed in conjunction with FIGS. 1(a) and 1(b). FIG. 1(a) illustrates the technical implementation of virtual teleportation in client server network architecture, while FIG. 1(b) illustrates implementation in a peer-to-peer network. The system 100 includes a plurality of objects 104, 112 and 124 located at plurality of teleportation terminals who are to be teleported. The host object 102 at host terminal initiates the teleportation session. Host object is present in a backdrop comprising of host background elements 104. The host scene is captured by the RGB sensor (camera) of a teleporting device 106 coupled to a computing device 108. After removal of background elements 102, 110 is the extracted alpha channeled RGB image with audio of the host object 104. The extracted image data 110 is transmitted from the host terminal via Internet through wired or wireless means to a real time teleportation server 132. In a peer-to-peer network the teleportation server 132 is not required FIG. 1(b) since the elements of the scene at the host and each of the participating terminals are transmitted directly between them in real time.

A remote object 112 at a remote teleportation terminal is present in a remote background 114. The remote scene at the remote terminal is captured by teleporting device 116 coupled to a computing device 118. 120 denotes the alpha channeled extracted image with embedded audio of remote object 112, which is transmitted via internet through wired or wireless means. Another remote object 122, at another remote teleportation terminal, is present along with remote background element 124. The remote scene at this remote terminal is captured by teleporting device 126 coupled to a computing device 128. 130 denotes the extracted image data of remote object 124, which is transmitted along with its corresponding alpha channeled background via internet through wired or wireless means. In a client-server network architecture FIG. 1(a), the teleportation server 132 inserts and manipulates each of the transmitted alpha-channeled object image data 110, 120 and 130 into the alpha channeled background areas of the host environment, so that each object image is overlaid distinct from each other on its pre-defined location in the teleported scene or environment. The environment that includes all the teleported objects participating in the teleportation session is then enhanced by inserting one or more background layers 134, and one or more foreground layers 136 into a composite teleported scene 138. Such background and foreground layers are retrieved from a database of computer generated graphic content. The final integrated composite teleported scene or environment 138 is then displayed on a display panel at each of the participating terminals. Such display is either a plasma display panel, or an LCD (liquid crystal display) panel, or an LED (light emitting diode), or an OLED (organic light emitting diode) display panel, or a video projector, or a see-through display screen, or a television set.

As illustrated in FIG. 1(b), in a peer-to-peer network, all the data processing steps are distributed and shared between the participating teleportation terminals, and the composite teleported scene 138 is generated at the client terminal itself and shared with each of the participating terminals seamlessly.

Each of the teleportation terminals is equipped with means to initiate, modify, pause or record a teleportation session, to invite, add or delete participants in a teleportation session. The participants of a teleportation session can also chose environment or virtual location (as defined by the foreground and background layers) they want to be teleported in. A practical implementation of the present invention can be a virtual conference taking place between participating teleportation terminals in a virtual environment created by the computer generated elements of the teleported scene simulating either a real world environment or a fictional environment. The integrated composite teleported scene of a teleportation session can be either recorded locally at one or more teleportation terminals, or broadcast live and made instantly available to one or more preselected remote destinations via an Internet, or a television satellite link, or a telecommunication link, or a wired or wireless local area network (LAN), or a wide area network (WAN), or a virtual private network (VPN) or intranet.

For connecting the participating teleportation terminals with each other the system uses any one of the communication protocols known to prior art such as TCP/IP protocol, GPRS protocol, WiFi protocol, a telecommunication link, a wired network, a wireless network, a virtual private network, intranet, wireless telecommunication protocol, Bluetooth, or a radiofrequency protocol.

In a variant of this embodiment one or more participating teleportation terminals deploy chroma-keying techniques for background removal. In yet another variant of the embodiment the host teleportation terminal does not deploy background removal. In another variant of this embodiment, the teleportation device coupled to its Internet enabled computing device is integrated within an LCD panel, an LED, an OLED display panel, a video projector, or a see-through display screen, or a television set. In yet another variant, the teleportation terminal is handheld communication device, or a head-mounted teleportation apparatus.

Having disclosed the technical aspects of a preferred embodiment is some detail, it is pertinent to walk through the practical implementation of the instant invention. FIG. 1(c) through FIG. 1(j) illustrate various steps from initiating a teleportation session to ending the session. While a convention keyboard/mouse can be used for executing all the teleportation related commands, all the commands can also be executed via gestures using the virtual interface of the invention as depicted herein. The teleportation session is initiated by activating the Teleportation Icon 140 on a virtual interface by means of hand gesture. The invitation to teleport is sent to selected participants from contact list FIG. 1(d). The invited participants accept the invite FIG. 1(e). The initiator of the teleportation session selects the location (such as under water expedition) session FIG. 1(f), which is followed with teleportation of the participants FIG. 1(g), FIG. 1(h), FIG. 1(i) to an underwater ship. Finally, at the conclusion of the teleportation session, the session initiator ends the session FIG. 1(j).

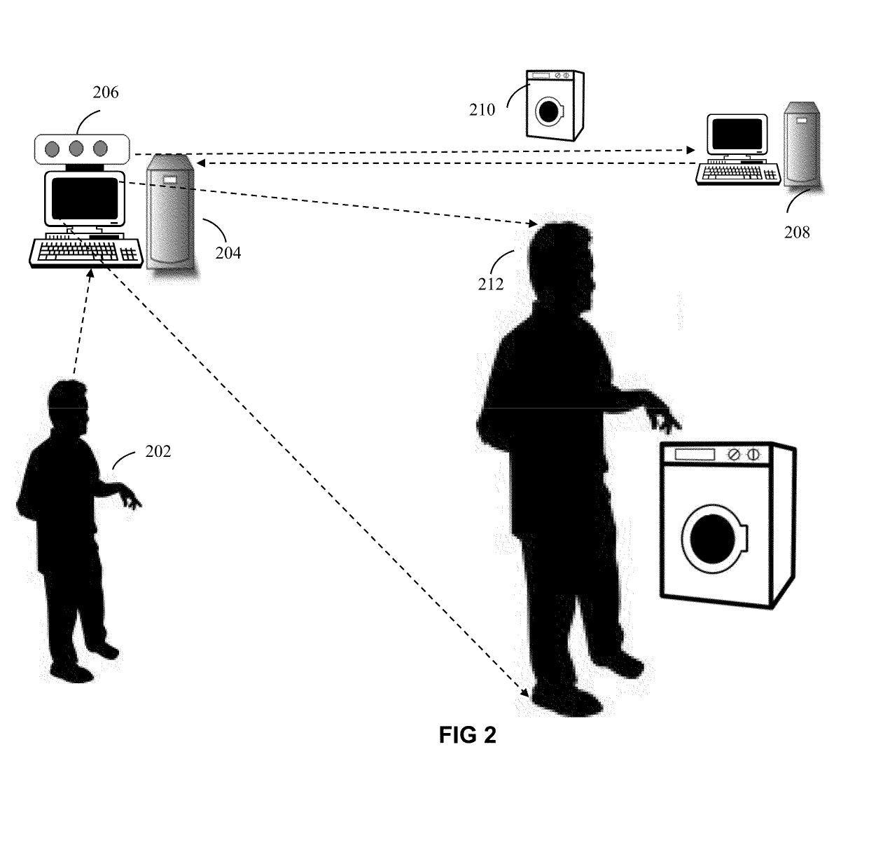

Referring now to FIG. 2, which illustrates another embodiment of the system facilitating virtual teleporting for an e-commerce application, in which a user is teleported into a 3D environment of a virtual store or showroom, a virtual shopping mall, or, a merchandise service center, and interacts with merchandises therein. In a variant of this embodiment, one or more merchandises are teleported into user's 3D environment for product demonstration, pre-purchase preview of goods, technical support, troubleshooting and service of pre-owned goods. 202 denotes a human subject or a user at a teleportation terminal 204.

The image parameters, audio and video data of 202 are captured via teleporting device 206 and transmitted to teleportation server 208 that hosts a database containing specifications, images, computer graphics and 3D models of merchandise, such as a given model of a washing machine 210. Upon initiation of a teleportation session by the user, the teleportation server 208 retrieves the computer-generated graphics pertaining to the washing machine 210 and transmits the merchandise data to the teleportation terminal 204, where it is inserted in the teleported scene 212 in user's 3D space as a foreground layer appearing in front of the user. Such an embodiment can be used for applications wherein several customers can be serviced remotely and conveniently for sales, marketing or troubleshooting of a product and thereby eliminating the need for a personal visit. Similar embodiments can be used in applications such as teaching and providing education to students remotely.

In another variant of ecommerce teleportation embodiment, instead of teleporting the merchandise object into user's 3D space, the user is teleported to a 3D environment of a virtual shopping mall or a store. Briefly, in the manner described in the first preferred embodiment as illustrated in FIG. 1, the user image captured at the user's teleportation terminal is extracted from the user environment and transmitted to the teleportation server where it is inserted into a teleported scene that includes foreground and background layers of computer graphics that create a real time in-store or in-mall shopping experience for the user.

The teachings of the instant invention is not limited to virtual teleportation of objects such as human subjects or material objects into a user's 3D space, but data entry means, navigation controls, or icons can also be teleported into user's 3D space between the user and the computer display, serving as voice or gesture responsive virtual interface. Such means of gesture or voice responsive computer-generated elements of virtual interface are retrieved from the application database and inserted as one or more foreground layers of the composite scene. These computer-generated graphic elements of virtual interface include:

a) virtual keyboard, virtual mouse, virtual touchpad, virtual pen of varying transparency to make other elements of the composite teleported scene behind the foreground layer visible to enable data input,

b) virtual menu for accessing different teleportation functions as well as navigating to other co-existing and unrelated client applications that include but not limited to, mail client, Internet browser, social networking applications, gaming applications, productivity applications,

c) virtual icons for displaying application links and alerts in real time.

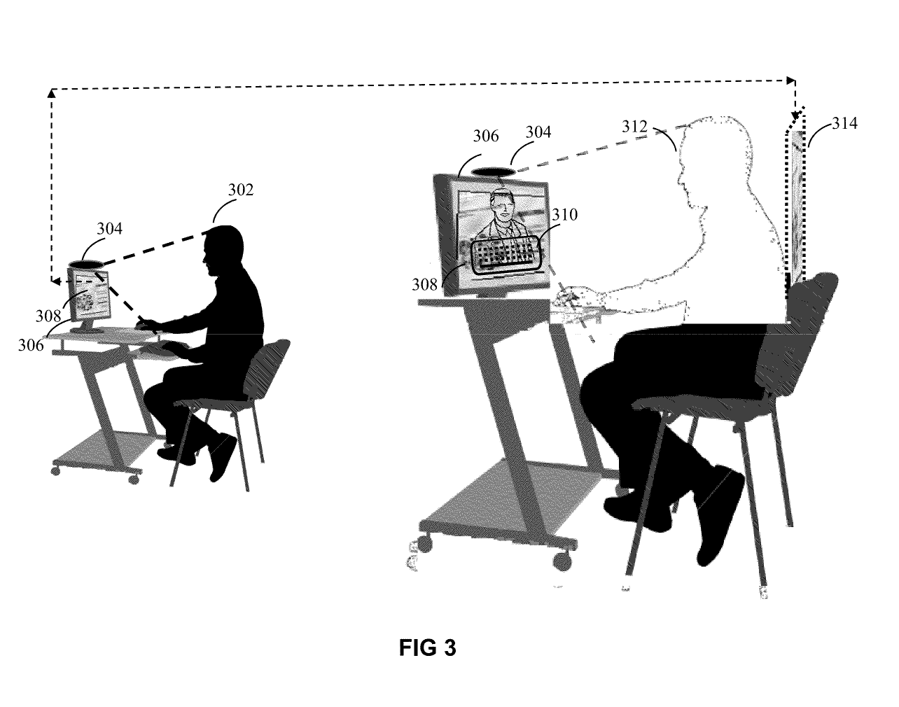

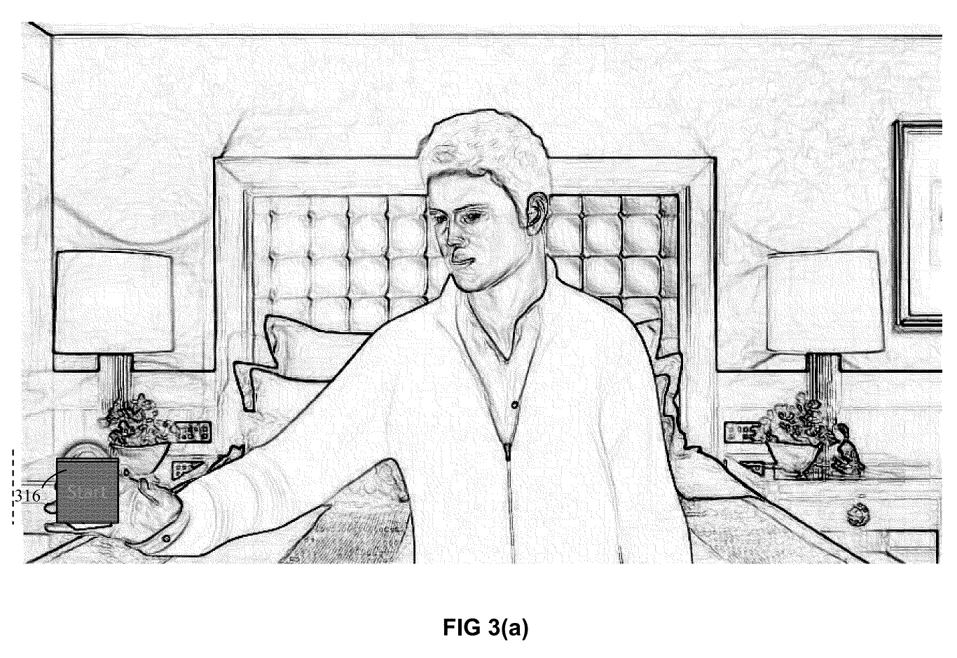

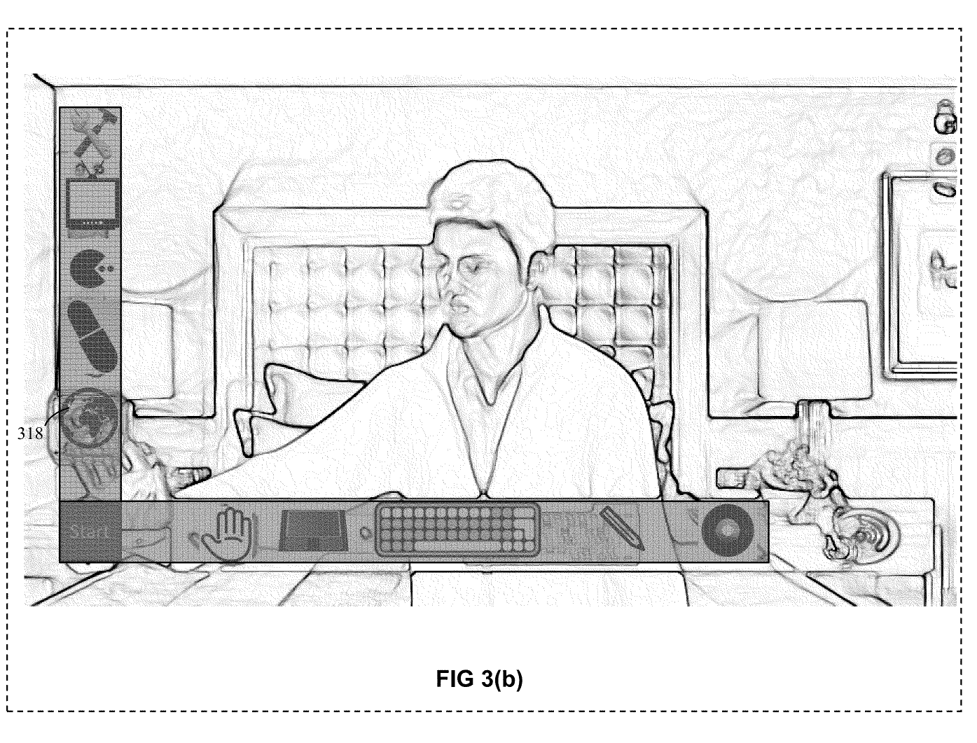

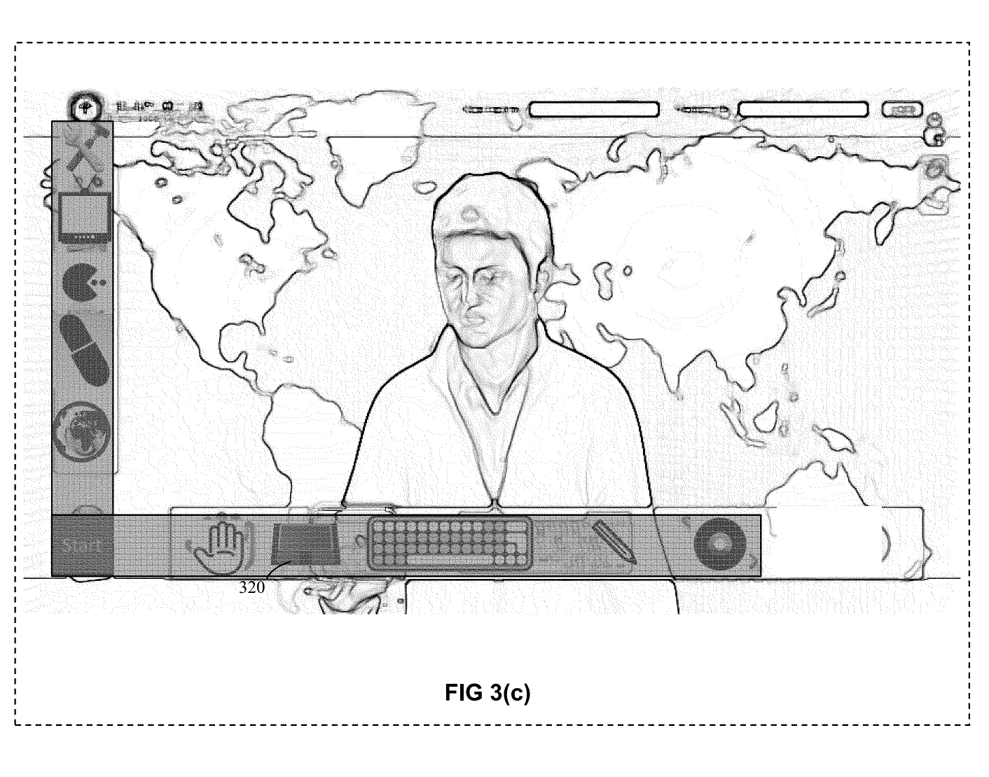

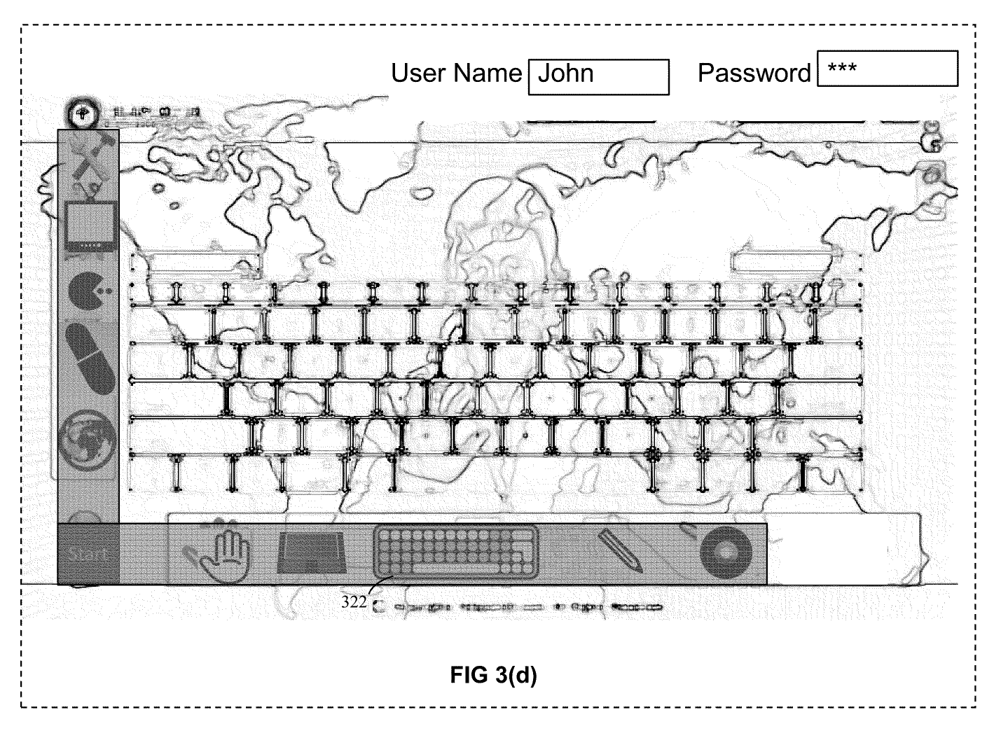

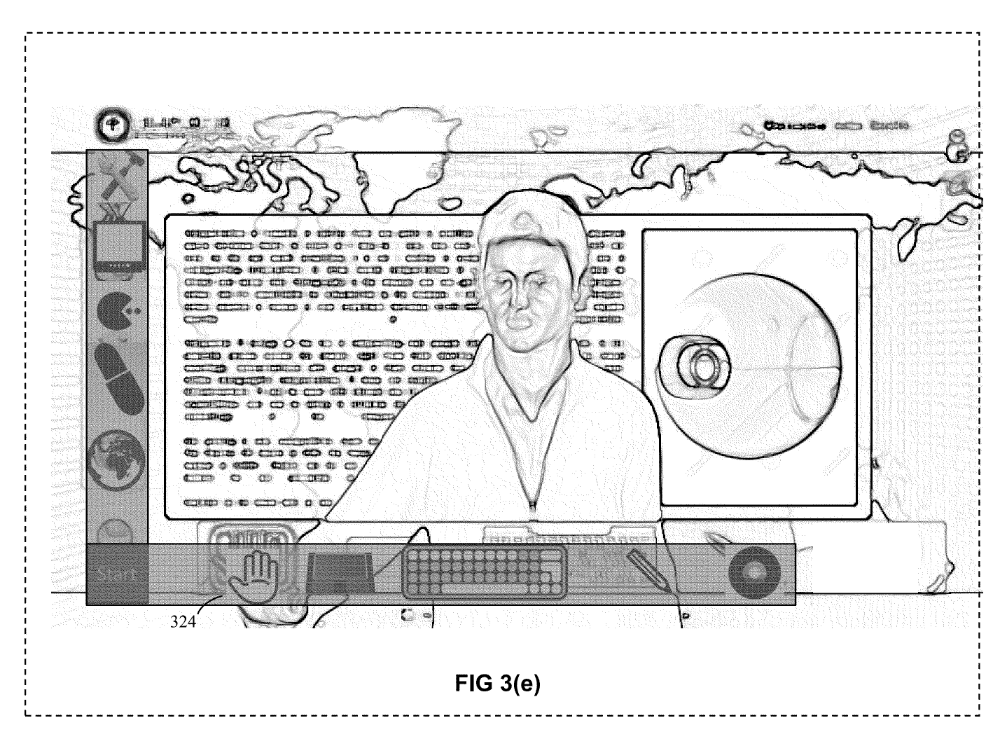

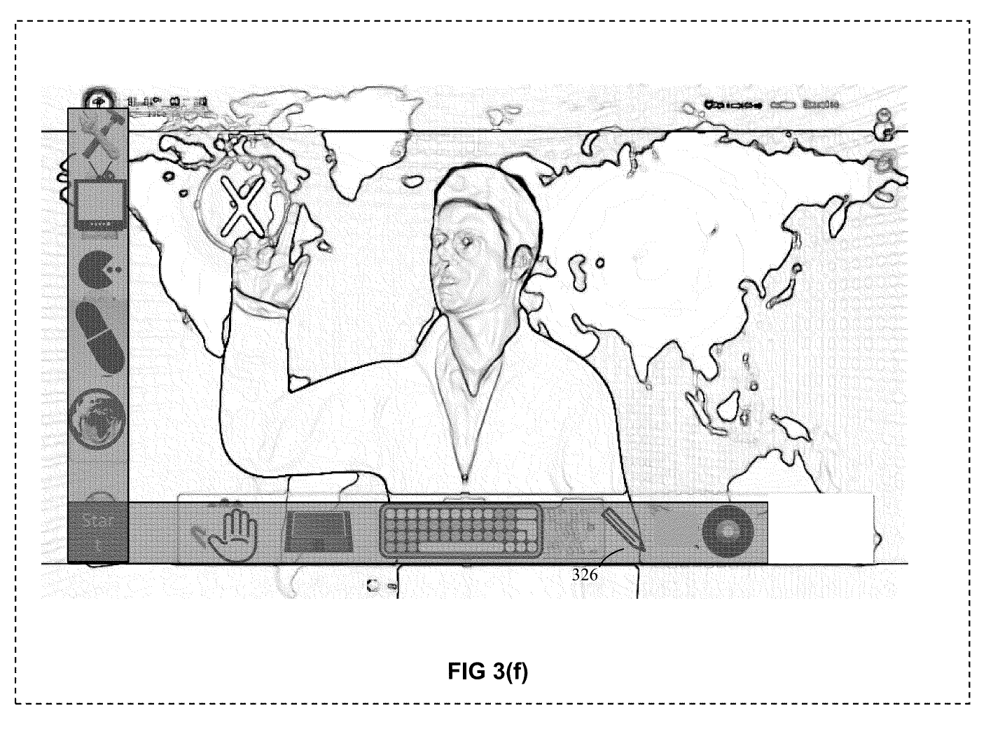

As illustrated in FIG. 3, such a system of a virtual interface application comprise of a computer (teleportation terminal) operated by a user 302 whose image along with his 3D space data is captured by a teleporting device (depth sensor plus RGB camera) 304 coupled to user's computer 306. The computer screen displays the interface of the target application 308 the user is working on. Such target application has fields in which the user is required to enter personal information by typing text. Implementing the features of the instant invention the user can perform all actions without using any data input hardware. This is achieved by means of first generating a 3D map of user's 3D space by means of data captured by the teleporting device 304 that is used for tracking user's hand movements. Computer-generated graphic elements of virtual interface from the application database are then retrieved and inserted as a foreground layer in user's 3D space. Such elements of virtual interface are rendered translucent so that the target application on the display screen is operationally visible to the user. Virtual keyboard 310 is an example of the elements of virtual interface. An association of each key on the virtual keyboard is established with the 3D map of user's 3D space, so that when user moves his finger in air to overlap on a specific key on the virtual keyboard the system matches the location of the specific key with the location of user's finger. To make both, the target application and virtual keyboard, clearly visible on screen, the user's image is rendered translucent 312. The screen view of the target application can be either rendered visible through the transparent foreground layer or captured in real time and screen capture inserted as background layer 314 of the user's camera view. The ultimate effect of this composition of the translucent foreground layer, the translucent user image and the target application's screen image in the background of the composition is that the target application, the virtual keyboard and user's fingers are all clearly visible to the user, and gives him an impression like the virtual keyboard is floating in air in between him and the target application interface displayed on the computer screen.

FIG. 3(a) through 3(f) further illustrate practical implementation of the instant embodiment wherein the user begins the method by launching the virtual interface application's START icon 316 by hand gesture, and then launching the target application 318 (Internet Browser) by hand gesture FIGS. 3(a) and 3(b). The user then activates the cursor by launching the virtual touchpad 320 to move the cursor to the data entry field on the target application page FIG. 3(c). To type the information in the data entry field FIG. 3(d) the user launches and uses the virtual keyboard 322. To move and scroll the page FIG. 3(e) the user can also launch the virtual page scrolling function 324. The user can also use the drawing tool function 326 to close the application FIG. 3(f).

Such an embodiment as illustrated in FIGS. 3 and 3(a)-3(f) enables the user to perform highly sophisticated operations remotely using hand movements and without touching any data input hardware or using any wearable or gesture recognition proximity hardware. Combining the disclosed virtual interface with voice-activated commands can impart unprecedented versatility to the instant invention. Such virtual interface embodiment can have widespread application as a visual and voice interface in gaming and entertainment facilitating sophisticated gesture based interaction and navigation. In a variant of virtual teleportation of virtual interface tools in user's virtual 3D space, the interface does not require any START or HOME button, but can just trigger the application links and navigation and other tools by just moving his hand to the edge of the display screen. Each of the four edges of the display screen can be assigned to specific group of virtual interface tools.

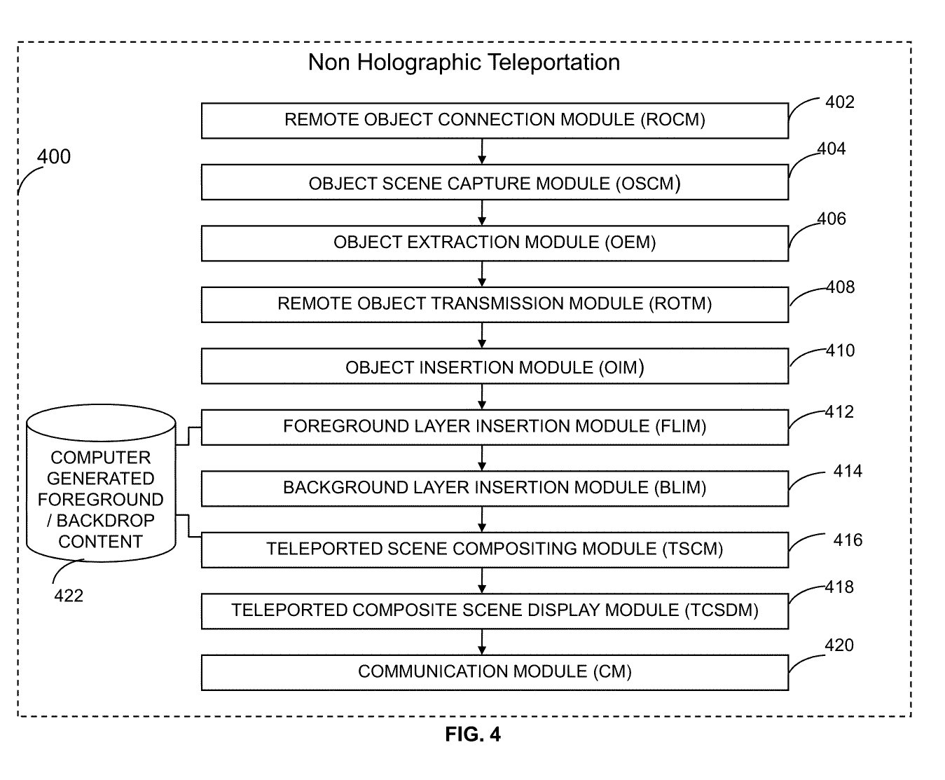

Referring now to FIG. 4, the drawing illustrates an exemplary block diagram depicting the operating modules of the system 400 for facilitating virtual teleporting of remote objects into user's 3D space using a non-holographic technique. The operating modules referred to hereunder may be present on a single or plurality of computing devices present at a single teleportation terminal location, or at plurality of teleportation terminals, or at remote teleportation servers.

System 400 comprises of Object Connection Module (OCM) 402, Object Scene Capture Module (OSCM) 404, Object Extraction Module (OEM) 406, Remote Object Transmission Module (ROTM) 408, Object Insertion Module (OIM) 410, Foreground Layer Insertion Module (FLIM) 412, Background Layer Insertion Module (BLIM) 414, Teleported Composite Scene Integration Module (TCSIM) 416, Teleported Composite Scene Display Module (TCSDM) 418, Communication Module (CM) 420, Computer Generated Foreground/Backdrop content database 422. These modules may be hosted on a local or remote server or distributed at multiple remote locations. Component 422 provides a means for storage of computer-generated foreground and background content including data in audio, video, animation, 3D image, map or text format. 424 serves as a repository of preselected computer-generated foreground and background content.

Component 402 is responsible for connecting one or more teleportation terminals with each other and to a common teleportation server. This connection may be achieved by wired or wireless means via an Internet or a telecommunication link, or a wired or wireless local area network (LAN), or a wide area network (WAN), or a virtual private network (VPN) or intranet. Component 404 is responsible for capturing the object scene comprising of a object along with object background by means of a teleporting device capable of sensing image attributes and depth parameters. Instances of teleporting devices include time-of-flight sensor based camera, structured light sensor based camera, dual camera depth sensor based camera, multiple camera array and digital image capturing devices capable of 2D pixel differentiation. Component 406 is responsible for distinguishing and separating the object from its immediate background using foreground/background segmentation techniques. Component 408 is responsible for transmitting selectively or completely, the extracted object image along with other image attributes such as RGB color, texture, audio, alpha channel from one teleportation terminal to the other or to the teleportation server. Component 410 combines the plurality of remote object images received from multiple remote locations for insertion into an integrated composite scene rendering individual remote images as part of the composite scene by manipulating them in terms of their image attributes. Component 412 is responsible for insertion of a layer of preselected computer graphics as a foreground layer while component 414 is responsible for insertion of a layer of preselected computer graphics as a background layer in the teleported integrated composite scene. Component 416 integrates said foreground layer, said background layer and remote object images in relation to each other for rendering a seamless customized view of a teleported scene. Component 418 is responsible for displaying the teleported integrated composite view in a display device such as a plasma display panel, an LCD (liquid crystal display) panel, an LED (light emitting diode), an OLED (organic light emitting diode) display panel or a video projector. Component 420 is responsible for transmitting and communicating the teleported integrated composite view to preselected destinations including, a handheld communication device, an email account, downloadable URL link of a remote server, so on and so forth. In different embodiments of present invention, the teleported integrated composite view is transmitted through wired or wireless telecommunication protocol, or TCP/IP protocol, or GPRS protocol or WiFi protocol or Bluetooth or radiofrequency protocol or IMAP, SMTP or a telecommunication protocol.

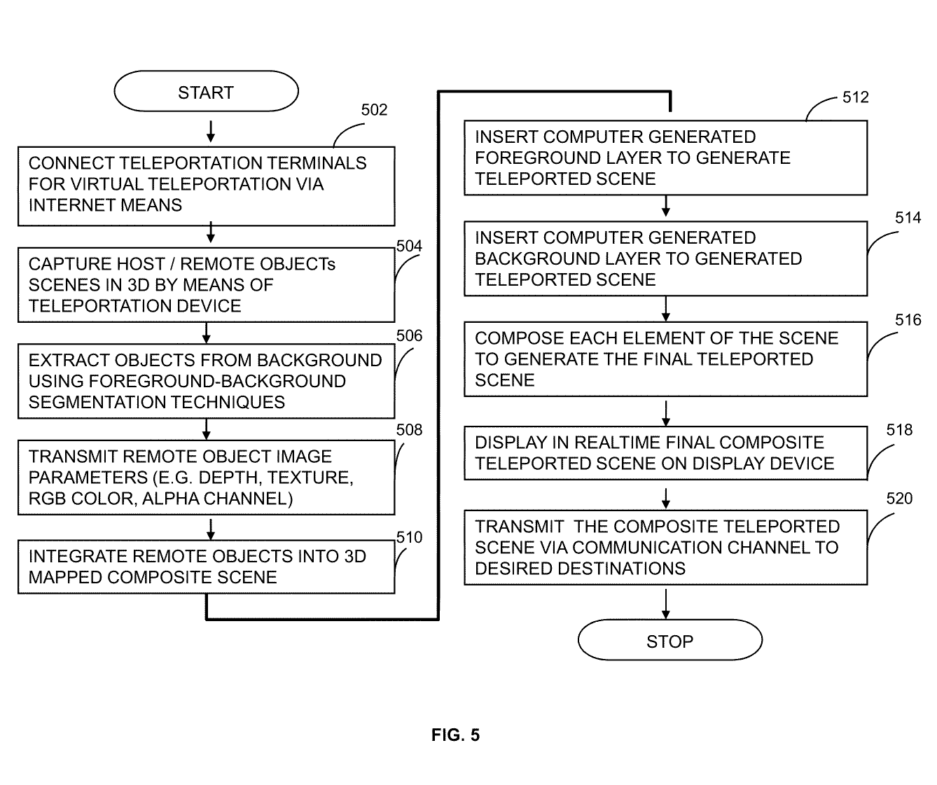

FIG. 5 depicts an exemplar methodology illustrating the steps followed in one aspect of the invention. It is to be understood and appreciated that the present invention is not limited by order of steps and that some of the steps may occur in different order and/or concurrently with other steps from that illustrated here. At step 502, one or more objects, located at geographically diverse teleportation terminals, which are required to be virtually teleported are connected via Internet means in real time. At step 504, the object scene at each of the participating terminals is captured in RGB along with its depth data by means of a teleporting device. At step 506, the remote object image is extracted from the remote background using one or more of foreground-background segmentation techniques. At step 508, image parameters of captured object at each of the participating teleportation terminals, such as color, texture, audio, alpha channel are transmitted either to a teleportation server when client-server network architecture is deployed, or directly to participating peers if peer-to-peer network architecture is deployed. At step 510, the transmitted object images are inserted and appropriately placed in relation to each other into a single composite scene. At step 512, a layer of computer-generated graphics that can act as virtual foreground layer is accessed from a database and inserted in the teleported scene. At step 514, a layer of computer-generated graphics that can act as virtual background layer is accessed from a database and inserted in the teleported scene. At step 516, each element of the teleported scene, i.e. each of the extracted remote objects, the extracted host object, the foreground and background layers of computer generated graphics, alpha channels, along with their corresponding audio channels are composed into a final composite teleported scene. At step 518, the integrated composite teleported scene is displayed in real time on a device such as a plasma display panel, an LCD (liquid crystal display) panel, an LED (light emitting diode), an OLED (organic light emitting diode) display panel or by a video projector. The displayed integrated teleported content including the composite background scene and remote objects is transmitted to one or more preselected destinations such as, a handheld communication device, an email account, downloadable URL link of a remote server, so on and so forth through wired or wireless telecommunication protocol, or TCP/IP protocol, or GPRS protocol or WiFi protocol or Bluetooth or radiofrequency protocol or a telecommunication protocol.

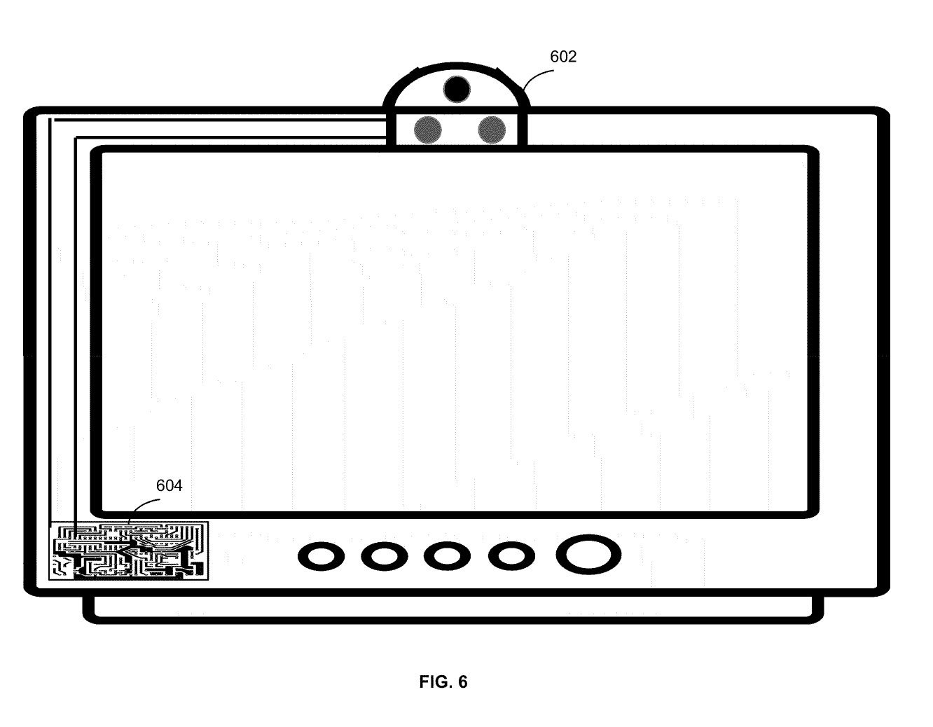

FIG. 6 illustrates another embodiment of the present invention in which the teleporting device 602 along with its computing hardware 604 and all the different modules are integrated within a television set or a display monitor so that such television set or display monitor itself functions as a fully functional teleportation terminal. Alternatively, this embodiment can also be practiced by compiling all the components (except the display device) of the teleportation system into a kit that can be provided as a teleportation accessory to a television set or a display panel.

In an embodiment of the present invention, the computer-generated graphics layers that may be used as foreground/background layers in the integrated teleported scene constitute a video gaming environment comprising of one or more virtual game characters or elements that the remote object(s) interact(s) with immersively, whether using hand or body gestures, or voice activated commands, or by using handheld game controller device.

In yet another embodiment of the present invention, only a part of the remote objects are teleported to the remote destination. This is achieved by manipulating the image of the remote object such that it appears partly transparent. Optionally, some of the remote objects may be rendered totally transparent, while some may be rendered translucent and some may be rendered as such while transmitting the image attributes such as color, texture, alpha channel, and audio channel. This embodiment can be used for providing a sophisticated gesture based computing interface.

In one embodiment of the present invention one or more teleportation terminals deploy chroma-keying techniques for background removal and object extraction. This is particularly important in showcasing a product or service such as an automobile, or a direct sales session for a fast moving consumer product to a large audience physically present in a high footfall public place such as shopping malls. In such an embodiment host teleportation terminal (public place) does not deploy any background removal or object extraction, while the remote terminal may either deploy chroma-key based or depth-based background removal. In another embodiment of the present invention, the plurality of remote objects may be the participants of a virtual conference, workshop, virtual training, etc., wherein the remote object image captured at remote teleporting terminal along with associated audio and video data is transmitted into the teleported scene at host terminal.

In a yet another embodiment of the present invention a useful, confidential and private means of one-on-one interaction is provided for communicating with strangers, such as encountered in social and dating networks. In this embodiment the user is teleported anonymously into a secure and private 3D environment of another unknown user without sharing any of their personal identification for the purpose of socializing or going on a blind date with a stranger. In still another embodiment the computer programs of one or more modules run remotely from a server via an active server webpage, or operate as a browser plugin, or run from an external drive of a computer.

Although the present invention has been particularly shown and described with reference to exemplary embodiments thereof, it will be understood by those of ordinary skill in the art that various changes in form and details may be made therein without departing from the spirit and scope of the present invention as defined by the appended claims. Therefore, the present embodiments are to be considered as illustrative and not restrictive and the invention is not to be limited to the written description.

The invention claimed is:

1. A computer-implemented method of virtually teleporting non-holographically, in real time, a plurality of objects or users located at diverse geographical locations, into a customized, seamless 3D environment, using a plurality of teleportation terminals, wherein the method comprises of the steps of:
a) a host teleportation terminal initiating connection via Internet means to one or more remote teleportation terminals participating in a teleportation session;
b) capturing each remote scene at plurality of participating terminals comprising of at least one remote object in a remote background and at least one host object in host background, by means of RGB sensor of a teleporting device coupled to an internet enabled computing device;
c) extracting each of the plurality of RGB device-captured object images from their corresponding remote backgrounds by means of a plurality of teleporting devices, coupled to their corresponding internet enabled computing devices;
d) transmitting each of the extracted RGB-captured remote object images along with their corresponding alpha channeled background for compositing the final teleportation scene or environment;
e) inserting each of the transmitted alpha-channeled object images into the alpha channeled background areas of the host environment;
f) inserting one or more background layers of retrieved computer-generated content to produce an integrated composite teleported scene or environment that includes all the objects participating in the teleportation session;
g) inserting one or more foreground layer of retrieved computer-generated content in the integrated composite teleported scene or environment;
h) compositing the final teleported scene by manipulating each element of the scene, so that each of the plurality of object images is overlaid distinct from each other on its pre-defined location in reference to the foreground and background layers in the teleported scene or environment;
i) displaying in real time the final integrated composite teleported scene or environment on a display panel at each of the participating terminals.

2. A method of claim 1, wherein the step (c) of extraction of object images from their corresponding backgrounds are achieved by 2D foreground segmentation technique comprising of 2D pixel recognition and differentiation.

3. A method of claim 1, wherein the step (c) of extraction of object images from their corresponding backgrounds is achieved by depth differentiation using any one, or combination thereof, of the following 3D background segmentation techniques:
a) Time-of-Flight imaging,
b) Structured light imaging,
c) Dual camera triangulation,
d) Multiple camera array of micro or nano cameras or lenses.

4. A method of claim 1, wherein data processing for one or more of the steps from a) through h) are:
a) shared equally by each of the participating terminals in a peer-to-peer network,
b) are implemented at a remote teleportation server in a client-server network.

5. A method of claim 1, wherein the teleporting device is a combination of devices that are coupled to an internet enabled computing device and comprise of:
a) at least one RGB sensor, which is a high definition camera with resolutions not less than 720P that captures the live object images at each of the teleportation terminal;
b) at least one audio sensor; and,
c) at least one depth sensor, which is based on generating 3D maps of the objects at each of the teleportation terminal using one of the following algorithms:
i) dual camera triangulation,
ii) multiple camera array,
iii) Time-of-Flight,
iv) structured light.

6. A method of claim 1, wherein the integrated composite teleported scene is either recorded locally at one or more teleportation terminals, or broadcast live and made instantly available to one or more preselected remote destinations via an Internet connection, or a television satellite link, or a telecommunication link, or a wired or wireless local area network (LAN), or a wide area network (WAN), or a virtual private network (VPN), or Intranet.

7. A method of claim 1, wherein the plurality of remote teleportation terminals are connected by means selected from a group comprising of internet protocol, a telecommunication link, a wired network, a wireless network, a virtual private network, intranet, wireless telecommunication protocol, TCP/IP protocol, GPRS protocol, WiFi protocol, Bluetooth, or a radiofrequency protocol.

8. A method of claim 1, wherein the foreground layer and the background layer of the integrated composite teleported scene constitute a 3D video gaming environment comprising of virtual game characters and elements that interact with one or more users immersively by means of voice, hand, body gestures or combination thereof.

9. A method of claim 1, wherein the plurality of remote and host objects are participants of a virtual conference that takes place in a virtual environment created by the computer generated elements of the teleported scene simulating either a real world environment, or a fictional environment.

10. A method of claim 1, wherein, either,
a) a user is teleported into a 3D environment of a virtual store or showroom, a virtual shopping mall, or, a merchandise service center, and interacts with merchandises therein, or,
b) merchandises are teleported into user's 3D environment for product demonstration, pre-purchase preview of goods, technical support, troubleshooting and service of pre-owned goods.

11. A method of claim 1, wherein a user is teleported anonymously into a secure and private 3D environment of another unknown user without sharing any of their personal identification for the purpose of socializing or going on a blind date with a stranger.

12. A method of claim 1, wherein one or more elements of the teleported scene are rendered transparent or translucent for providing pre-defined level of visibility to hidden or masked elements.

13. A method of claim 1, wherein at least one background or foreground layer is replaced by a live screen capture of the desktop that a user is interacting with, and, one or more transparent or translucent foreground layers comprising of computer graphics that operate as virtual computing interface, displaying voice or gesture responsive data entry means, navigation controls or icons that include but not limited to:
a) virtual keyboard, virtual mouse, virtual touchpad, virtual pen of varying transparency to make other elements of the composite teleported scene behind the foreground layer visible to enable data input;
b) virtual menu for accessing different teleportation functions as well as navigating to other co-existing and unrelated client applications that include but not limited to, mail client, Internet browser, social networking applications, gaming applications, productivity applications;
c) virtual icons for displaying application links and alerts in real time.

14. A method of claim 1, wherein the display is a plasma display panel, an LCD (liquid crystal display) panel, an LED (light emitting diode), an OLED (organic light emitting diode) display panel, a video projector, or a see-through display screen, or a television set.

15. A method of claim 1, wherein the teleportation device coupled to its Internet enabled computing device is integrated within an LCD panel, an LED, an OLED display panel, a video projector, or a see-through display screen, or a television set.

16. A method of claim 1, wherein the teleportation terminal is handheld communication device, or a head-mounted teleportation apparatus.

17. A method of claim 1, wherein one or more participating teleportation terminals deploy chroma-keying techniques for background removal.

18. A method of claim 1, wherein the host teleportation terminal does not deploy background removal.

19. A system of virtually teleporting a plurality of remote objects from plurality of remote teleportation terminals in real time into a customized, seamless 3D environment of a host object's host teleportation terminal, by means of a plurality of teleporting devices coupled to a plurality of internet enabled computing devices, comprising of:
a) Remote Object Connection Module (ROOM) which is a set of computer programs that is used to logically connect one or more remote objects via internet means;
b) Object Scene Capture Module (OSCM), which is a set of computer programs that receive, as input from RGB sensor, the image of object scene in real time from the teleporting device;
c) Object Extraction Module (OEM) which is a set of computer programs that deploy either 2D pixel recognition and differentiation techniques for foreground segmentation, or, 3D depth sensors for foreground-background segmentation to extract object with alpha channel from background of the captured object scene in real time;
d) Remote Object Transmission Module (ROTM) which is a set of computer programs that transmit in real time, to a host object terminal, the extracted image of a remote object along with associated parameters, that include but not limited to depth, texture, color, alpha channel;
e) Object Insertion Module (OIM) which is a set of computer programs that integrates, places and composes in real time one or more remote teleported objects within alpha channeled areas of extracted host object image scene;
f) Background Layer Insertion Module (BLIM), which is a set of computer programs that inserts a pre-defined background layer of computer graphics to the composition of teleported scene in real time;
g) Foreground Layer Insertion Module (FLIM), which is a set of computer programs that inserts a pre-defined foreground layer of computer graphics to the composition of teleported scene in real time;
h) Teleported Scene Compositing Module (TSCM), which is a set of computer programs that integrates and fine tunes in real time the composition of host and remote objects with background and foreground layers of computer graphics to produce a live composition of teleported environment;
i) Teleported Composite Scene Display Module (TCSDM) which is a set of computer programs that display in real time the integrated, composite teleported scene on display devices of each of the participating teleportation terminals;
j) Central Processing Unit (CPU), which analyzes and executes the operations of ROCM, OSCM, OEM, ROTM, OIM, FLIM, BLIM, TSBLIM, TCSM, TCSDM.

20. A method of claim 19, wherein the integrated composite teleported scene is either recorded locally at one or more teleportation terminals, or broadcast live and made instantly available to one or more preselected remote destinations via an Internet connection, or a television satellite or a telecommunication link, or a wired or wireless local area network (LAN), or a wide area network (WAN), or a virtual private network (VPN) or intranet.

21. A method of claim 19, wherein the plurality of remote objects are connected by means selected from a group comprising of internet protocol, a telecommunication link, a wired network, a wireless network, a virtual private network, intranet, wireless telecommunication protocol, TCP/IP protocol, GPRS protocol, WiFi protocol, Bluetooth, radiofrequency protocol, a telecommunication protocol.

22. A method of claim 19, wherein the foreground layer and the background layer of the integrated composite teleported scene constitute a 3D video gaming environment comprising of virtual game characters and elements that interact with one or more users immersively by means of voice, hand, or body gestures.

23. A method of claim 19, wherein the plurality of remote and host objects are participants of a virtual conference that takes place in a virtual environment created by the computer generated elements of the teleported scene simulating either a real world environment or a fictional environment.

24. A method of claim 19, wherein, either,
a) a user is teleported into a 3D environment of a virtual store or showroom, a virtual shopping mall, or, a merchandise service center, and interacts with merchandises therein; or,
b) merchandises are teleported into one or more users' 3D environment for product demonstration, pre-purchase preview of goods, technical support, troubleshooting and service of pre-owned goods.

25. A method of claim 19, wherein a user is teleported anonymously into a secure and private 3D environment of another unknown user without sharing any of their personal identification for the purpose of socializing or going on a blind date with a stranger.

26. A system of claim 19, wherein one or more foreground layers comprise of computer graphics that operate as virtual computing interface displaying voice or gesture responsive data entry means and navigation controls or icons that include but not limited to:
a) virtual keyboard, virtual mouse, virtual touchpad, virtual pen of varying transparency to make other elements of the composite teleported scene behind the foreground layer visible to enable data input;
b) virtual menu for accessing different teleportation functions as well as navigating to other co-existing and unrelated client applications that include but not limited to, mail client, Internet browser, social networking applications, gaming applications, productivity applications;
c) virtual icons for displaying alerts in real time.

27. A system of claim 19, wherein the computer programs of one or more modules run remotely from a server via an active server webpage, or operate as a browser plugin, or run from an external drive of a computer.

28. A system of claim 19, wherein a Communication Module (CM) which is a set of computer programs that stream live the integrated, composite teleported scene to one or more preselected remote destinations.

29. A system of claim 19, wherein one or more teleportation terminals deploy chroma keying techniques for background removal.

30. A method of claim 19, wherein the host teleportation terminal does not deploy background removal.

31. A system of claim 19, wherein modules (a) through (h) and module (j) are compiled as a kit that can be incorporated into a television set or a display panel.
